(19) United States
(12) Patent Application Publication
(10) Pub. No.: US 2024/0378376 A1
(43) Pub. Date: Nov. 14, 2024

(54) METHOD, APPARATUS, ELECTRONIC DEVICE AND STORAGE MEDIUM FOR PROCESSING TABLE DATA

(71) Applicant: Beijing Zitiao Network Technology Co., Ltd., Beijjing (CN)

(72) Inventor: Zhijie ZHENG, Beijjing (CN)

(21) Appl. No.: 18/659,904

(22) Filed: May 9, 2024

(30) Foreign Application Priority Data
May 9, 2023 (CN) 202310518566.2

(51) Int. Cl. G06F 40/18; G06F 40/109

(52) U.S. Cl. CPC G06F 40/18; G06F 40/109

(57) ABSTRACT

A method, an apparatus, an electronic device and a storage medium for processing table data include determining whether a first cell of a spreadsheet is located in a pivot table region; if the first cell is located in the pivot table region, determining a value of the first cell based on a pivot table module, which is configured to store information of a pivot table in the spreadsheet; if the first cell does not belong to the pivot table region, determining a value of the first cell based on data stored in the spreadsheet itself. Data of the pivot table is connected to the spreadsheet with a proxy mode. The two independent functions of the pivot table and the spreadsheet are combined, so that data can be directly acquired from the pivot table module and rendered on the spreadsheet without depending on a formula capability of the spreadsheet itself.

### CROSS-REFERENCE

This application claims the benefit of Chinese Patent Application No. 202310518566.2, filed on May 9, 2023, entitled “METHOD, APPARATUS, ELECTRONIC DEVICE AND STORAGE MEDIUM FOR PROCESSING TABLE DATA”, which is hereby incorporated by reference in its entirety.

### FIELD

The present disclosure relates to the field of computer technologies, and in particular, to a method, an apparatus, an electronic device, and a storage medium for processing table data.

### BACKGROUND

A pivot table is an interactive analysis tool capable of rapidly summarizing and analyzing table data, and can automatically classify and sort data in a target region in a spreadsheet, execute statistical methods such as counting, summing and calculating an average value, and may be displayed at a specified position of the spreadsheet or in other tables. A pivot table provided by a related spreadsheet application generally depends on a formula capability of the table, for example, a function of the pivot table is implemented through a formula such as ARRAYFORMULA. However, the pivot table implemented in this manner has many problems, for example, being easy to report an error, and being difficult to support various style setting and exception condition determination.

### SUMMARY

This Summary is provided to introduce the concepts in a simplified form that are further described below in the Detailed Description. This Summary is not intended to identify key features or essential features of the claimed subject matter, nor is it intended to be used to limit the scope of the claimed subject matter.

In the first aspect, according to one or more embodiments of this disclosure, a method for processing table data is provided, comprising:
determining whether a first cell of a spreadsheet is located in a pivot table region;
in accordance with a determination that the first cell is located in the pivot table region, determining a value of the first cell based on a pivot table module; wherein the pivot table module is configured to store information of a pivot table in the spreadsheet;
in accordance with a determination that the first cell does not belong to the pivot table region, determining a value of the first cell based on data stored in the spreadsheet itself.

In the second aspect, according to one or more embodiments of this disclosure, an apparatus for processing table data is provided, comprising:
a cell determining unit configured to determine whether a first cell of a spreadsheet is located in a pivot table region;
a cell valuing unit configured to, in accordance with a determination that the first cell is located in the pivot table region, determine a value of the first cell based on a pivot table module, and in accordance with a determination that the first cell does not belong to the pivot table, determine a value of the first cell based on data stored in the spreadsheet itself;
the pivot table module is configured to store information of a pivot table in the spreadsheet.

In the third aspect, according to one or more embodiments of this disclosure, an electronic device is provided, comprising: at least one memory and at least one processor; wherein the memory is configured to store program code, and the processor is configured to invoke the program code stored in the memory to cause the electronic device executes the method for processing table data provided according to one or more embodiments of this disclosure.

In the fourth aspect, according to one or more embodiments of this disclosure, a non-transitory computer storage medium is provided. The non-transitory computer storage medium stores program code, the code when executed by a computer device cause the computer device to execute the method for processing table data provided according to one or more embodiments of this disclosure.

According to one or more embodiments of the present disclosure, it is determined whether a first cell of a spreadsheet is located in a pivot table region; in accordance with a determination that the first cell is located in the pivot table region, determining a value of the first cell based on a pivot table module; wherein the pivot table module is configured to store information of a pivot table in the spreadsheet; in accordance with a determination that the first cell does not belong to the pivot table region, determining a value of the first cell based on data stored in the spreadsheet itself. In such a way, data of the pivot table is connected to the spreadsheet with a proxy mode. The two independent functions of the pivot table and the spreadsheet are combined, so that data can be directly acquired from the pivot table module and rendered on the spreadsheet without depending on a formula capability of the spreadsheet itself.

### BRIEF DESCRIPTION OF THE DRAWINGS

The above and other features, advantages, and aspects of various embodiments of the present disclosure will become more apparent with reference to the following detailed description taken in conjunction with the accompanying drawings. The same or like reference numerals represent the same or like elements throughout the drawings. It should be understood that the drawings are illustrative and that the elements and primaries are not necessarily drawn to scale.

FIG. 1 is a flowchart of a method for processing table data according to an embodiment of the present disclosure;

FIG. 2 is a flowchart of a method for processing table data according to another embodiment of the present disclosure;

FIG. 3 is a flowchart of method for processing table data according to yet another embodiment of the present disclosure;

FIG. 4 is a schematic structural diagram of an apparatus for processing table data according to an embodiment of the present disclosure;

FIG. 5 is a schematic structural diagram of an electronic device according to an embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as being limited to the embodiments set forth herein, but rather these embodiments are provided for a thorough and complete understanding of the present disclosure. It should be understood that the drawings and embodiments of the present disclosure are only for illustrative purposes and are not intended to limit the scope of the present disclosure.

It should be understood that the steps recited in the embodiments of the present disclosure may be performed in a different order and/or in parallel. In addition, embodiments may comprise additional steps and/or omit performance of the illustrated steps. The scope of the present disclosure is not limited in this respect.

The term “comprising” and variations thereof, as used herein, are intended to be inclusive, i.e., “comprising but not limited to”. The term “based on” means “based at least in part on”. The term “one embodiment” means “at least one embodiment”; the term “other embodiment” means “at least one other embodiment”; the term “some embodiments” means “at least some embodiments”. The term “in response to” and related terms mean that a signal or event is affected to some degree by another signal or event, but not necessarily wholly or directly. If event x occurs “in response to” event y, then x may be directly or indirectly in response to y. For example, the occurrence of y may ultimately cause the occurrence of x, but there may be other intervening events and/or conditions. In other cases, y may not necessarily result in the occurrence of x, and x may occur even though y has not yet occurred. Furthermore, the term “in response to” may also mean “in response at least in part to”.

The term “determine” encompasses a wide variety of actions, comprising obtaining, calculating, computing, processing, deriving, investigating, looking up (e.g., looking up in a table, a database or other data structure), ascertaining and the like, and may comprise receiving (e.g., receiving information), accessing (e.g., accessing data in a memory) and the like as well as parsing, selecting, choosing, establishing and the like. Relevant definitions of other terms will be given in the following description. Relevant definitions of other terms will be given in the following description.

It should be noted that, the “first”, “second”, and other concepts mentioned in the present disclosure are only used to distinguish different apparatuses, modules, or units, but are not used to limit the sequence or dependency of functions performed by these apparatuses, modules, or units.

It should be noted that the modifications of “one” and “more” mentioned in the present disclosure are illustrative rather than restrictive, and those skilled in the art should understand that they should be understood as “one or more” unless the context clearly indicates otherwise.

For the purposes of the present disclosure, the phrase “A and/or B” means (A), (B), or (A and B).

The names of messages or information interacted between a plurality of apparatuses in the embodiments of the present disclosure are only for illustrative purposes, and are not intended to limit the scope of these messages or information.

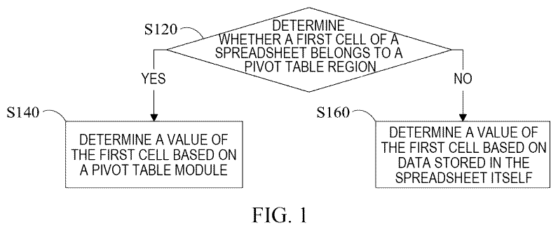

Referring to FIG. 1, which shows a flowchart of a method 100 for processing table data according to an embodiment of the present disclosure. The method 100 comprises step S120 to step S160.

Step S120: determining whether a first cell of a spreadsheet is located in a pivot table region.

In some embodiments, a spreadsheet may be an online table that is edited online by a user, cooperated by multiple users, and saved in a cloud in real time. The spreadsheet may be displayed through a hypertext markup language (HTML) page, and synchronize the contents edited by users depending on communication between a client and a server.

In some embodiments, an execution subject of the method 100 may be a client, for example, an instant messaging (IM) client. The client incorporates the functions of a spreadsheet. Based on a click operation of a user, the client invokes a browser kernel via an interface provided by the browser to load a page of the spreadsheet. A user may create and edit a spreadsheet based on the loaded page. The user may certainly share the spreadsheet through the client. In other embodiments, a browser kernel is integrated in the client. A page for displaying a spreadsheet in the client is realized by invoking the browser kernel. In other embodiments, the client is a spreadsheet client, in which case a page of a spreadsheet is loaded and displayed by running the spreadsheet client. In other embodiments, there is an applet corresponding to spreadsheet function. In such case, a client implements the loading and display of a page of a spreadsheet by downloading and running source code of the spreadsheet applet. In addition, in other embodiments, the execution subject of the method 100 may also be a server.

In some embodiments, the first cell may be any cell in a spreadsheet or a designated cell, which is not limited in this disclosure.

A pivot table is an interactive analysis tool capable of rapidly summarizing and analyzing table data, and may automatically classify and sort data in a target region in an electronic table, and execute statistical approaches such as counting, summing and calculating an average value.

The pivot table region comprises a region of the spreadsheet for presenting pivot table contents. In some embodiments, the body portion of the pivot table region comprises a row region, a column region and a value region. In one possible arrangement, if the row and column region are also adjacent to a region formed by one or more cells (e.g., a corner region located at a corner of the pivot table), the region may also belong to the body portion of the pivot table region.

In some embodiments, the pivot table region comprises, in addition to the body portion, a filtering region for controlling a range of data presented by the body portion of the pivot table. As an example, if the body portion of the pivot table is used for presenting sales statistical data of all sales persons in a whole period, the filtering region may be used for filtering a statistical period. The user may control the statistical period in the filtering region, so that the body portion of the table only contains the sales statistical data of a partial period.

In some embodiments, the data structure of a pivot table layout may comprise, but is not limited to, variables corresponding to the foregoing filtering region, row region, column region, value region, and corner region, as well as variables used to determine the format of the data within the pivot table. The data structure of the pivot table may be a data structure similar with a two-dimensional array, so that the pivot table can be conveniently imported into a spreadsheet product.

Step S140: in accordance with a determination that the first cell is located in the pivot table region, determining a value of the first cell based on a pivot table module; wherein the pivot table module is configured to store information of a pivot table in the spreadsheet.

Step S160: in accordance with a determination that the first cell does not belong to the pivot table region, determining a value of the first cell based on data stored in the spreadsheet itself.

In some embodiments, a pivot table module (for example, a pivot table manager) may be a pre-constructed module for implementing a pivot table function, and may manage a pivot table in a spreadsheet to store information of the pivot table in the spreadsheet.

In some embodiments, the information, stored by the pivot table module, of the pivot table in the spreadsheet may comprise, but is not limited to, value information of each cell in the pivot table, style information of each cell, and information of the pivot table region. Further, in some embodiments, the information described above is not stored in a spreadsheet that only needs to store location information for the pivot table, for example, the coordinates of the top left corner of the pivot table in the spreadsheet.

In some embodiments, the pivot table module is a separate module independent of the spreadsheet. In this embodiment, the pivot table is a separate module independent of the formula capability of the spreadsheet. Exemplarily, the pivot table may be a function or service independent of the spreadsheet, and the data of the pivot table and the data of the spreadsheet are stored in different data models respectively. In one specific implementation, the spreadsheet need only store location information (e.g., coordinates) of the pivot table in the spreadsheet.

When data is rendered in a spreadsheet, a corresponding data model is iterated, and data of each cell is read out and rendered on a table canvas. However, data of a pivot table in an embodiment of the present disclosure is stored in a separate data model. Therefore, during iterations, it is required to determine whether a cell is located in a pivot table region, so as to determine a data model from which a value is taken. For cells that belong to the pivot table, the data of the pivot table is returned, and for cells that do not belong to the pivot table, the original data of the spreadsheet is returned.

In this way, in the embodiments of the present disclosure, data of a pivot table is connected to a spreadsheet with a proxy mode. The two independent functions of the pivot table and the spreadsheet are combined, so that data can be directly acquired from a pivot table module and rendered on the spreadsheet without depending on a formula capability of the spreadsheet itself.

In some embodiments, the method 100 further comprises:
Step A1: in accordance with a determination that the first cell is located in the pivot table region, determining a first style corresponding to the first cell based on the pivot table module;
Step A2: determining a second style corresponding to the first cell based on the spreadsheet;
Step A3: determining a style of the first cell based on the first style and the second style.

In some embodiments, the first style may be a default style that the pivot table sets for the first cell; and the second style may be a style that the spreadsheet sets for the first cell. The style may comprise one or more of font style, font color style, font size style, fill color style and border style.

In some embodiments, the type of the second style may comprise, but is not limited to, a conditional format style, a locality style, a cell style, and a spreadsheet default style. The conditional format style is a style set by a conditional format function, which is used for setting a style of a plurality of cells in batches according to a predetermined rule. The locality style is a style of some contents in a cell. For example, a user may set a style of texts therein by setting a locality style of a certain cell. The cell style is opposite to the locality style, reflecting the overall style of cells.

In some embodiments, step A3 further comprises: merging the first style and the second style to obtain the style of the first cell; wherein display priorities of the first style and the second style are sequentially from high to low: a conditional format style (if any), a locality style (if any), a cell style (if any), a first style and a spreadsheet default style.

In this embodiment, the final style of the first cell is obtained by merging the first style and various types of the second style. If the first style and a certain type of second style have different settings for the same object (e.g., font, font size, font color, cell filled color, and line type, color, thickness of cell border, etc.), the final style of the object may be determined according to the described priority. As an example, if the first cell belongs to the pivot table region, the default style (namely, the first style) set by the pivot table for the first cell is blue filled color and white font A, the spreadsheet default style is white filled color and black font B, and the cell style set by the user in the spreadsheet is font C, the filled color of the first cell is determined to be red according to the conditional format set by a user in the spreadsheet, then the final style of the first cell is red filled color and white font C.

According to one or more embodiments of the present disclosure, on the one hand, the style of the pivot table may be designed separately, by enabling the style (namely, the first style) of a pivot table to be independent from the style (namely, the second style) of a spreadsheet, so that abundant style settings may be supported, for example, setting a row region or a column region of the pivot table to be in a style different from that of a value region, supporting merging of cells, etc. On the other hand, by determining the cell style based on the first style and the second style, it can be supported to aggregate the style of the pivot table with the original style of the spreadsheet.

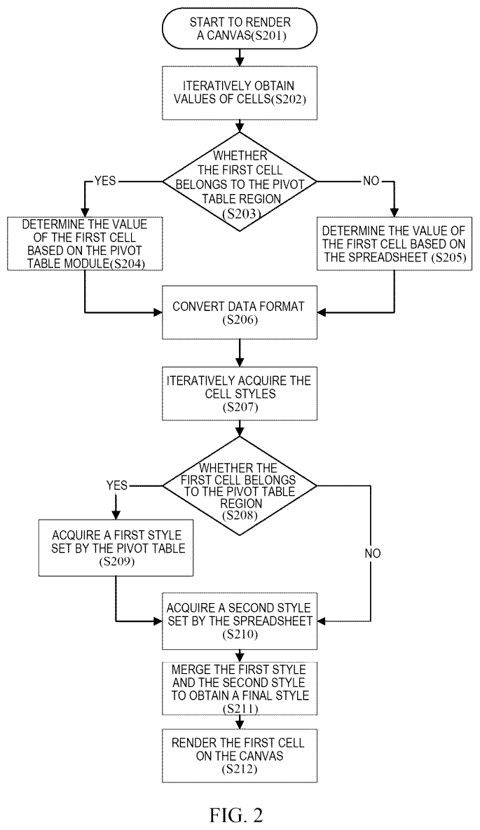

FIG. 2 shows a flowchart of a method 200 for processing table data provided by another embodiment of the present disclosure. The method 200 comprises step S201 to step S212.

Step S201: starting to render a canvas of a spreadsheet.

Step S202: iteratively obtaining values of cells of a spreadsheet. For example, an iterContent iterator may be used to traverse the values of each cell.

Step S203: determining whether the first cell is located in the pivot table region. If it is determined that the first cell is located in the pivot table region, then performing step S204; otherwise, step S205 is executed.

Step S204: determining the value of the first cell based on the pivot table module. For example, the value of the first cell stored in a relevant data model (for example, a viewModel) in a pivot table manager (PivotTableManager) may be acquired.

Step S205: acquiring the value of the first cell based on the spreadsheet. For example, the value of the first cell may be acquired from a related data model (for example, ContentModel) of the spreadsheet.

Step S206: converting a data format of the acquired values into a data format currently used by the spreadsheet. For example, if the acquired value is 1 and the data format used by the current spreadsheet is to reserve two decimal fractions, the final value of the first cell is 1.00.

Step S207: iteratively acquiring the cell styles of the spreadsheet. For example, an iterStyle iterator may be used to traverse the cell styles.

Step S208: determining whether the first cell is located in the pivot table region. If it is determined that the first cell is located in the pivot table region, then executing steps S209 and S210; otherwise, step S210 is executed.

Step S209: acquiring a first style set by the pivot table module for the first cell. Exemplarily, a default style value of the pivot table may be acquired from a related data model (for example, ThemeModel) in the pivot table manager.

Step S210: acquiring a second style set by the spreadsheet for the first cell. Exemplarily, a value of the second style may be acquired from a related data model (for example, a style Mode) of the spreadsheet.

Step S211: merging the first style and the second style to obtain a final style of the first cell.

Step S212: based on the obtained value and final style of the first cell, rendering the content of the first cell on the canvas.

In some embodiments, steps S203-S207 and S208-S212 may be performed for each cell within the spreadsheet to ultimately render the obtained entire spreadsheet.

In some embodiments, the method for processing table data further comprises:
Step B1: in response to an editing operation performed by a user on the pivot table, determining an edited pivot table region;
Step B2: determining whether the edited pivot table region covers original cells filled with data in the spreadsheet;
Step B3: in accordance with a determination that the edited pivot table region covers original cells filled with data in the spreadsheet, displaying query information for querying whether the user agrees to cover the cells filled with data;
Step B4: in response to an instruction that the user agrees to cover the cells filled with data, covering the cells filled with data with the edited pivot table.

The inventor has found through research that, in a related technical solution of implementing a pivot table depending on an array formula capability, when a pivot table region may cover an original cell filled with data in a spreadsheet, an error is directly reported, so that the pivot table cannot be displayed according to an operation intention of a user.

In this regard, according to the method for processing table data provided by one or more embodiments of the present disclosure, when it is determined that an edited pivot table region covers original cells filled with data in a spreadsheet, a user is queried whether to agree to cover the cells, and in response to an instruction that the user agrees, the cells are covered, so that the pivot table can be displayed according to an operation intention of the user.

Generally, in the process of processing table data, an additional step of querying a user usually blocks a table data processing flow, since the intermediate calculation result, configuration information and the like before the query need to be stored in a memory, which additionally consumes a relatively high memory resource. It is especially true for a related technical solution of implementing a data pivot table depending on an array formula capability. In this regard, according to the solution of adopting a pivot table with a proxy mode provided by the present disclosure, a spreadsheet does not need to implement complex calculations such as an array formula, and only needs to take a value from a pivot table module, thereby reducing the influence of flow blocking and memory consumption caused by a query step.

In some embodiments, the method for processing table data further comprises:

Step B5: in response to an instruction that the user does not agree to cover cells filled with data, restoring a configuration of the pivot table prior to the editing operation.

In this embodiment, in response to an instruction that the user does not agree to cover cells filled with data, the configuration of the pivot table prior to the editing operation is restore, that is, the editing operation is not effective.

In some embodiments, before the determining whether the edited pivot table region covers original cells filled with data in the spreadsheet, whether the edited pivot table region overlaps with other pivot tables in the spreadsheet may be determined. In accordance with a determination that the edited pivot table region overlaps with other pivot tables in the spreadsheet, predetermined prompt information is displayed to prompt a user that the editing operation is not effective. In this embodiment, if the edited pivot table region covers other pivot tables in the spreadsheet, the editing operation is prevented from taking effect and data coverage between the two pivot tables is avoided.

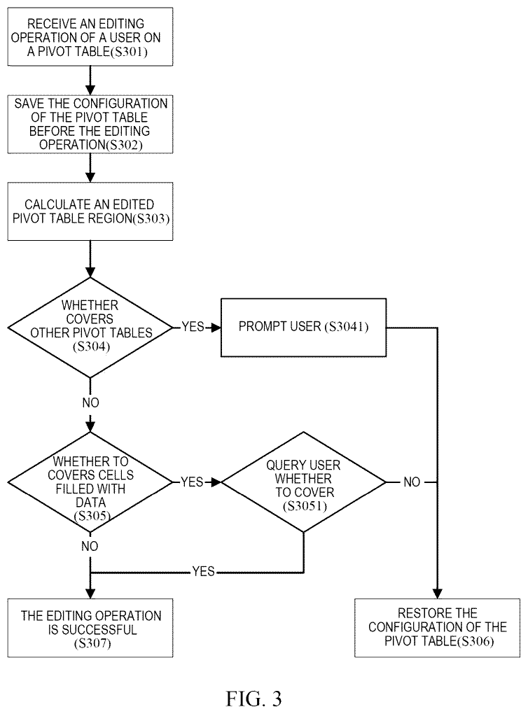

FIG. 3 shows a flowchart of a method 300 for processing table data provided by yet another embodiment of the present disclosure. The method 300 comprises step S301 to step S307.

Step S301: receiving an editing operation of a user on a pivot table. Exemplarily, the editing operation may comprise an operation of changing a position of the pivot table in a spreadsheet, or an operation of editing fields in various regions of the pivot table.

Step S302: saving the configuration of the pivot table before the editing operation.

Step S303: calculating an edited pivot table region according to the editing operation. The calculated edited pivot table region is a region of a spreadsheet to be covered by the pivot table in response to the editing operation.

Step S304: determining whether the edited pivot table region covers other pivot tables within the spreadsheet. If yes, step S3041 and step S306 are performed; otherwise, step S305 is performed.

Step S3041: displaying predetermined prompt information to prompt the user that the editing operation is not effective.

Step S306: restoring the configuration of the pivot table in the editing operation, so that the editing operation is not effective.

Step S305: determining whether the edited pivot table region covers original cells filled with data in the spreadsheet. If yes, step S3051 is performed; otherwise, step S307 is performed.

Step S3051: querying whether the user agrees to cover the cells filled with the data. If the user agrees, step S307 is performed; otherwise, step S306 is performed.

Step S307: the editing operation is successful. Exemplarily, a response corresponding to the editing operation may be executed, for example, updating the position of the pivot table, displaying content, and covering cells filled with data. For the online spreadsheet, a collaborative notification may further be sent to the server to update the server, so that the execution result of the editing operation may also be reflected on other clients.

In some embodiments, determining a pivot table region comprises:
Step C1: determining a location of the pivot table in the spreadsheet;
Step C2: determining a number of rows and a number of columns of the pivot table;
Step C3: determining the pivot table region based on the location, the row number, and the number of columns.

For example, a position (for example, coordinates) of a part (for example, top left corner) of the pivot table in the spreadsheet may be determined as the position of the pivot table in the spreadsheet. The number of rows and the number of columns of the pivot table represent the size (height and width) of the pivot table region. For example, the spreadsheet has columns A-G and rows 1-10, the top left corner of the pivot table is located in column C and row 2 and has 3 rows and 2 columns, then in the spreadsheet, the pivot table region is columns C-D and rows 2-4, i. e. cells C2, D2, C3, D3, C4 and D4 belong to the pivot table region.

It can be understood that if the pivot table is edited by the user, the position, the number of rows and the number of columns of the edited pivot table region may be determined based on the editing operation, thereby the information of the pivot table may be determined. If the user moves the pivot table, the position of the pivot table will change, but the number of rows and the number of columns will not change. If the user modifies the configuration of the pivot table, the number of rows or number of columns of the pivot table may change while the position does not change.

In some embodiments, the storage information for the pivot table module may be updated based on the determined pivot table region.

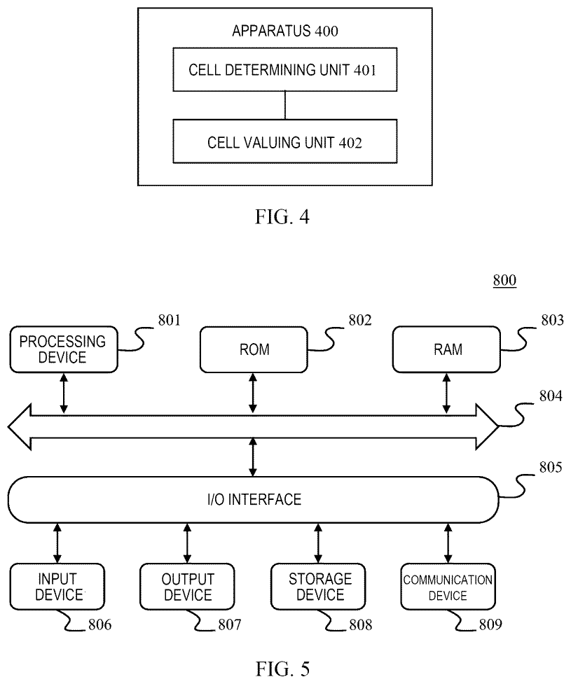

Accordingly, referring to FIG. 4, there is provided an apparatus 400 for processing table data according to an embodiment of the present disclosure, comprising:
a cell determining unit 401 configured to determine whether a first cell of a spreadsheet is located in a pivot table region;
a cell valuing unit 402 configured to, in accordance with a determination that the first cell is located in the pivot table region, determine a value of the first cell based on a pivot table module, and in accordance with a determination that the first cell does not belong to the pivot table, determine a value of the first cell based on data stored in the spreadsheet itself;
the pivot table module is configured to store information of a pivot table in the spreadsheet.

In some embodiments, the pivot table module is a separate module independent of the spreadsheet.

In some embodiments, the information of the pivot table in the spreadsheet stored by the pivot table module comprises: value information of each cell, style information of each cell and information of the pivot table region.

In some embodiments, the apparatus for processing table data further comprises:
a cell style determining unit configured for, in accordance with a determination that the first cell is located in the pivot table region, determining a first style corresponding to the first cell based on the pivot table module, determining a second style corresponding to the first cell based on the spreadsheet, and determining a style of the first cell based on the first style and the second style.

According to one or more embodiments of present disclosure, the second style comprises one or more of the following: a conditional format style, a locality style, a cell style, and a spreadsheet default style; the determining a style of the first cell based on the first style and the second style comprises: merging the first style and the second style to obtain the style of the first cell; wherein display priorities of the first style and the second style are sequentially from high to low: a conditional format style, a locality style, a cell style, a first style and a spreadsheet default style.

In some embodiments, the apparatus for processing table data further comprises:
a region determining unit configured for, in response to an editing operation performed by a user on the pivot table, determining an edited pivot table region;
a filled data determining unit configured for determining whether the edited pivot table region covers original cells filled with data in the spreadsheet;
a query unit configured for, in accordance with a determination that the edited pivot table region covers original cells filled with data in the spreadsheet, displaying query information for querying whether the user agrees to cover the cells filled with data;
a filling unit configured for, in response to an instruction that the user agrees to cover the cells filled with data, covering the cells filled with data with the edited pivot table.

In some embodiments, the apparatus for processing table data further comprises:
a restoring unit configured for, in response to an instruction that the user does not agree to cover cells filled with data, restoring a configuration of the pivot table prior to the editing operation.

In some embodiments, the apparatus for processing table data further comprises:
a data table overlap determining unit configured for, before determining whether the edited pivot table region covers original cells filled with data in the spreadsheet, determining whether the edited pivot table region overlaps with other pivot tables in the spreadsheet;
a prompt unit configured for, in accordance with a determination that the edited pivot table region overlaps with other pivot tables in the spreadsheet, displaying predetermined prompt information to prompt a user that the editing operation is not effective.

In some embodiments, determining a pivot table region comprises: determining a location of the pivot table in the spreadsheet; determining a number of rows and a number of columns of the pivot table; determining the pivot table region based on the location, the row number, and the number of columns.

The apparatus embodiments substantially correspond to the method embodiments, thus the relevant parts thereof may be described with reference to the method embodiment. The apparatus embodiments described above are merely exemplary, and modules described as separate modules may or may not be separated. A part or all of the modules may be selected according to actual needs to achieve the objectives of the solutions of the embodiments. A person of ordinary skill in the art may understand and implement the present application without creative efforts.

Accordingly, according to one or more embodiments of the present disclosure, there is provided an electronic device, comprising:
at least one memory and at least one processor;
wherein the memory is configured to store program code, and the processor is configured to invoke the program code stored in the memory to cause the electronic device executes the method for processing table data provided by one or more embodiments of present disclosure.

Accordingly, according to one or more embodiments of the present disclosure, there is provided a non-transitory computer storage medium storing program code, the code when executed by a computer device cause the computer device to execute a method for processing table data provided by one or more embodiments of the present disclosure.

Referring now to FIG. 5, which shows a schematic structural diagram of an electronic device (for example, terminal device or server) 800 suitable for implementing embodiments of the present disclosure. The terminal device in the embodiment of the present disclosure may comprise, but is not limited to, a mobile terminal such as a mobile phone, a laptop computer, a digital broadcast receiver, a PDA (Personal Digital Assistant), a PAD (tablet computer), a PMP (Portable Multimedia Player), an onboard terminal (such as an onboard navigation terminal) and the like, and a fixed terminal such as a digital TV, a desktop computer, and the like. The electronic device shown in FIG. 5 is merely an example and should not limit the functions and scope of use of embodiments of the present disclosure in any way.

As shown in FIG. 5, the electronic device 800 may comprise a processing device (e.g., central processing unit, graphics processor, etc.) 801 that may perform various suitable actions and processes in accordance with a program stored in read only memory (ROM) 802 or a program loaded into random access memory (RAM) 803 from storage 808. The RAM 803 also stores various programs and data necessary for the operation of the electronic device 800. The processing device 801, the ROM 802, and the RAM 803 are connected to each other via the bus 804. An input/output (I/O) interface 805 is also connected to bus 804.

In general, the following apparatus may be connected to the I/O interface 805: input device 806 comprising, for example, touch screen, touch pad, keyboard, mouse, camera, microphone, accelerometer, gyroscope, etc.; an output device 807 comprising, for example, a liquid crystal displays (LCD), speaker, vibrator, or the like; a storage 808 comprising, for example, a magnetic tape, a hard disk, or the like; and a communication device 809. The communication device 809 may allow the electronic device 800 to wirelessly or wired communicate with other devices to exchange data. While FIG. 5 illustrates an electronic device 800 with a variety of apparatuses, it is to be understood that not all of the illustrated apparatuses are required to be implemented or provided. More or fewer apparatuses may alternatively be implemented or provided.

In particular, the processes described above with reference to the flowcharts may be implemented as computer software programs in accordance with embodiments of the present disclosure. For example, embodiments of the present disclosure comprise a computer program product comprising a computer program carried on a computer readable medium. The computer program comprises a program code for executing the method as shown in the flowchart. In such an embodiment, the computer program may be downloaded and installed from the network via communication device 809, installed from storage device 808, or installed from ROM 802. When the computer program is executed by the processing device 801, the described functions defined in the method of embodiments of the present disclosure are executed.

It should be noted that the computer readable medium in the present disclosure may be a computer readable signal medium or a computer readable storage medium, or any combination thereof. A computer readable storage medium may be, for example, but not limited to, an electronic, magnetic, optical, electromagnetic, infrared, or semiconductor system, apparatus, or device, or any combination thereof. More specific examples of the computer readable storage medium may comprise, but are not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that contain or store a program for use by or in connection with an instruction execution system, apparatus, or device. While in the present disclosure, a computer readable signal medium may comprise a data signal carrying computer readable program code in baseband or propagated as a part of carrier wave. Such a propagated signal may take any of a variety of forms, comprising, but not limited to, electro-magnetic, optical signal, or any suitable combination thereof. A computer readable signal medium may also be any computer readable medium in addition to a computer readable storage medium, and that can send, propagate, or transmit a program for use by or in connection with an instruction execution system, apparatus, or device. Program code embodied on a computer readable medium may be transmitted using any appropriate medium, comprising, but not limited to, wire, optical fiber cable, RF (radio frequency), etc., or any suitable combination thereof.

In some implementations, clients, servers may communicate using any currently known or future developed network protocol such as HTTP (Hypertext Transfer Protocol) and may be interconnected with digital data communication (e.g., a communication network) in any form or medium. Examples of communication networks comprise a local area network (“LAN”), a wide area network (“WAN”), an internetwork (e.g., the Internet), and a peer-to-peer network (e.g., an ad hoc peer-to-peer network), as well as any currently known or future developed network.

The computer readable medium may be comprised in the electronic device, or may exist separately and not be installed in the electronic device.

The above computer readable medium carries one or more programs, which when executed by the electronic device, cause the electronic device to execute the method disclosed above.

The computer program code for carrying out operations of the present disclosure may be written in any combination of one or more programming languages, comprising an object oriented programming language such as Java, Smalltalk, C++, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the case of remote computer, the remote computer may be connected to the user's computer through any type of network, comprising a local area network (LAN) or a wide area network (WAN), or the connection may be made to an external computer (for example, through the Internet using an Internet Service Provider).

The flowcharts and block diagrams in the figures illustrate the architecture, functionality, and operation of possible implementations of systems, methods and computer program products according to various embodiments of the present disclosure. In this regard, each block in the flowcharts or block diagrams may represent a module, program segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

The units involved in the embodiments of the present disclosure may be implemented through software or hardware. The name of a unit does not constitute a limitation to the unit itself in a certain case.

The functions described herein above may be performed, at least in part, by one or more hardware logic components. For example, without limitation, exemplary types of hardware logic components that can be used comprise Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In the context of this disclosure, a machine readable medium may be tangible media that may contain or store a program for use by or in connection with an instruction execution system, apparatus, or device. The machine readable medium may be a machine readable signal medium or a machine readable storage medium. The machine readable medium may comprise, but is not limited to, an electronic, magnetic, optical, electromagnetic, infrared, or semiconductor system, apparatus, or device, or any suitable combination of the foregoing. More specific examples of machine readable storage media would comprise an electrical connection based on one or more wires, a portable computer diskette, a hard disk, a random access memory (RAM), a read-only memory (ROM), an erasable programmable read-only memory (EPROM or flash memory), an optical fiber, a compact disc read-only memory (CD-ROM), an optical storage device, a magnetic storage device, or any suitable combination of the foregoing.

According to one or more embodiments of the present disclosure, there is provide a method for processing table data, comprising: determining whether a first cell of a spreadsheet is located in a pivot table region; in accordance with a determination that the first cell is located in the pivot table region, determining a value of the first cell based on a pivot table module; wherein the pivot table module is configured to store information of a pivot table in the spreadsheet; in accordance with a determination that the first cell does not belong to the pivot table region, determining a value of the first cell based on data stored in the spreadsheet itself.

According to one or more embodiments of the present disclosure, the pivot table module is a separate module independent of the spreadsheet.

According to one or more embodiments of the present disclosure, the information of the pivot table in the spreadsheet stored by the pivot table module comprises: value information of each cell, style information of each cell and information of the pivot table region.

According to one or more embodiments of the present disclosure, the method for processing table data further comprises: in accordance with a determination that the first cell is located in the pivot table region, determining a first style corresponding to the first cell based on the pivot table module; determining a second style corresponding to the first cell based on the spreadsheet; determining a style of the first cell based on the first style and the second style.

According to one or more embodiments of the present disclosure, the second style comprises one or more of the following: a conditional format style, a locality style, a cell style, and a spreadsheet default style; the determining a style of the first cell based on the first style and the second style comprises: merging the first style and the second style to obtain the style of the first cell; wherein display priorities of the first style and the second style are sequentially from high to low: a conditional format style, a locality style, a cell style, a first style and a spreadsheet default style.

According to one or more embodiments of the present disclosure, the method for processing table data further comprises: in response to an editing operation performed by a user on the pivot table, determining an edited pivot table region; determining whether the edited pivot table region covers original cells filled with data in the spreadsheet; in accordance with a determination that the edited pivot table region covers original cells filled with data in the spreadsheet, displaying query information for querying whether the user agrees to cover the cells filled with data; in response to an instruction that the user agrees to cover the cells filled with data, covering the cells filled with data with the edited pivot table.

According to one or more embodiments of the present disclosure, the method for processing table data further comprises: in response to an instruction that the user does not agree to cover cells filled with data, restoring a configuration of the pivot table prior to the editing operation.

According to one or more embodiments of the present disclosure, before the determining whether the edited pivot table region covers original cells filled with data in the spreadsheet, the method for processing table data further comprising: determining whether the edited pivot table region overlaps with other pivot tables in the spreadsheet; in accordance with a determination that the edited pivot table region overlaps with other pivot tables in the spreadsheet, displaying predetermined prompt information to prompt a user that the editing operation is not effective.

According to one or more embodiments of the present disclosure, determining a pivot table region comprises: determining a location of the pivot table in the spreadsheet; determining a number of rows and a number of columns of the pivot table; determining the pivot table region based on the location, the row number, and the number of columns.

According to one or more embodiments of the present disclosure, there is provided an apparatus for processing table data, comprising: a cell determining unit configured to determine whether a first cell of a spreadsheet is located in a pivot table region; a cell valuing unit configured to, in accordance with a determination that the first cell is located in the pivot table region, determine a value of the first cell based on a pivot table module, and in accordance with a determination that the first cell does not belong to the pivot table, determine a value of the first cell based on data stored in the spreadsheet itself; the pivot table module is configured to store information of a pivot table in the spreadsheet.

According to one or more embodiments of the present disclosure, there is provided an electronic device, comprising: at least one memory and at least one processor; wherein the memory is configured to store program code, and the processor is configured to invoke the program code stored in the memory to cause the electronic device executes the method for processing table data provided according to one or more embodiments of the present disclosure.

According to one or more embodiments of the present disclosure, there is provided a non-transitory computer storage medium storing program code, the code when executed by a computer device cause the computer device to execute a method for processing table data provided according to one or more embodiments of the present disclosure.

The foregoing description is merely illustrative of the preferred embodiments of the present disclosure and of the technical principles applied thereto. As will be appreciated by those skilled in the art, the scope of the present disclosure is not limited to the technical solution formed by the specific combination of the described technical features, but should cover other technical solutions formed by any combination of the described technical features or equivalent features thereof without departing from the described disclosed concept, for example, the technical solutions that are formed by replacing the above features and technical features having similar functions disclosed in the present disclosure (but not limited thereto).

In addition, while operations are depicted in a particular order, this should not be understood as requiring that the operations be performed in the particular order shown or in sequential order. Multitasking and parallel processing may be advantageous in certain circumstances. Likewise, while several specific implementation details are comprised in the above discussion, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments separately or in any suitable subcombination.

Although the subject matter has been described in language specific to structural features and/or methodological acts, it should be understood that the subject matter defined in the appended claims is not necessarily limited to the specific features or acts described above. Rather, the specific features and acts described above are merely exemplary forms of implementing the claims.

What is claimed is:

1. A method for processing table data, comprising:
determining whether a first cell of a spreadsheet is located in a pivot table region;
in accordance with a determination that the first cell is located in the pivot table region, determining a value of the first cell based on a pivot table module; the pivot table module being configured to store information of a pivot table in the spreadsheet; and
in accordance with a determination that the first cell does not belong to the pivot table region, determining a value of the first cell based on data stored in the spreadsheet itself.

2. The method of claim 1, wherein, the pivot table module is a separate module independent of the spreadsheet.

3. The method of claim 1, wherein, the information of the pivot table in the spreadsheet stored by the pivot table module comprises: value information of each cell, style information of each cell and information of the pivot table region.

4. The method of claim 1, further comprising:
in accordance with a determination that the first cell is located in the pivot table region, determining a first style corresponding to the first cell based on the pivot table module;
determining a second style corresponding to the first cell based on the spreadsheet; and
determining a style of the first cell based on the first style and the second style.

5. The method of claim 4, wherein, the second style comprises at least one of the following: a conditional format style, a locality style, a cell style or a spreadsheet default style;
and wherein determining a style of the first cell based on the first style and the second style comprises: merging the first style and the second style to obtain the style of the first cell, and display priorities of the first style and the second style are sequentially from high to low: a conditional format style, a locality style, a cell style, a first style and a spreadsheet default style.

6. The method of claim 1, further comprising:
in response to an editing operation performed by a user on the pivot table, determining an edited pivot table region;
determining whether the edited pivot table region covers original cells filled with data in the spreadsheet;
in accordance with a determination that the edited pivot table region covers original cells filled with data in the spreadsheet, displaying query information for querying whether the user agrees to cover the cells filled with data; and
in response to an instruction that the user agrees to cover the cells filled with data, covering the cells filled with data with the edited pivot table.

7. The method of claim 6, further comprising:
in response to an instruction that the user does not agree to cover cells filled with data, restoring a configuration of the pivot table prior to the editing operation.

8. The method of claim 6, further comprising:
before the determining whether the edited pivot table region covers original cells filled with data in the spreadsheet, determining whether the edited pivot table region overlaps with other pivot tables in the spreadsheet; and
in accordance with a determination that the edited pivot table region overlaps with other pivot tables in the spreadsheet, displaying predetermined prompt information to prompt a user that the editing operation is not effective.

9. The method of claim 1, wherein determining the pivot table region comprises:
determining a location of the pivot table in the spreadsheet;
determining a number of rows and a number of columns of the pivot table; and
determining the pivot table region based on the location, the row number, and the number of columns.

10. An electronic device, comprising:
at least one memory and at least one processor;
wherein the memory is configured to store program code, and the processor is configured to invoke the program code stored in the memory to cause the electronic device to:
determine whether a first cell of a spreadsheet is located in a pivot table region;
in accordance with a determination that the first cell is located in the pivot table region, determine a value of the first cell based on a pivot table module; the pivot table module being configured to store information of a pivot table in the spreadsheet; and
in accordance with a determination that the first cell does not belong to the pivot table region, determine a value of the first cell based on data stored in the spreadsheet itself.

11. The electronic device of claim 10, wherein, the pivot table module is a separate module independent of the spreadsheet.

12. The electronic device of claim 10, wherein, the information of the pivot table in the spreadsheet stored by the pivot table module comprises: value information of each cell, style information of each cell and information of the pivot table region.

13. The electronic device of claim 10, wherein the electronic device is further caused to:
in accordance with a determination that the first cell is located in the pivot table region, determine a first style corresponding to the first cell based on the pivot table module;
determine a second style corresponding to the first cell based on the spreadsheet; and
determine a style of the first cell based on the first style and the second style.

14. The electronic device of claim 13, wherein, the second style comprises at least one of the following: a conditional format style, a locality style, a cell style or a spreadsheet default style;
and wherein the electronic device is further caused to: determine a style of the first cell based on the first style and the second style by: merging the first style and the second style to obtain the style of the first cell, and display priorities of the first style and the second style are sequentially from high to low: a conditional format style, a locality style, a cell style, a first style and a spreadsheet default style.

15. The electronic device of claim 10, wherein the electronic device is further caused to:
in response to an editing operation performed by a user on the pivot table, determine an edited pivot table region;
determine whether the edited pivot table region covers original cells filled with data in the spreadsheet;
in accordance with a determination that the edited pivot table region covers original cells filled with data in the spreadsheet, display query information for querying whether the user agrees to cover the cells filled with data; and
in response to an instruction that the user agrees to cover the cells filled with data, cover the cells filled with data with the edited pivot table.

16. The electronic device of claim 15, wherein the electronic device is further caused to:
in response to an instruction that the user does not agree to cover cells filled with data, restore a configuration of the pivot table prior to the editing operation.

17. The electronic device of claim 15, wherein the electronic device is further caused to:
before the determining whether the edited pivot table region covers original cells filled with data in the spreadsheet, determine whether the edited pivot table region overlaps with other pivot tables in the spreadsheet; and
in accordance with a determination that the edited pivot table region overlaps with other pivot tables in the spreadsheet, display predetermined prompt information to prompt a user that the editing operation is not effective.

18. The electronic device of claim 1, wherein the electronic device is further caused to: determine the pivot table region by:
determining a location of the pivot table in the spreadsheet;
determining a number of rows and a number of columns of the pivot table; and
determining the pivot table region based on the location, the row number, and the number of columns.

19. A non-transitory computer storage medium storing program code, the program code when executed by a computer device causing the computer device to:
determine whether a first cell of a spreadsheet is located in a pivot table region;
in accordance with a determination that the first cell is located in the pivot table region, determine a value of the first cell based on a pivot table module; the pivot table module being configured to store information of a pivot table in the spreadsheet; and
in accordance with a determination that the first cell does not belong to the pivot table region, determine a value of the first cell based on data stored in the spreadsheet itself.

20. The non-transitory computer storage medium of claim 19, wherein the pivot table module is a separate module independent of the spreadsheet.
